(19) United States
(12) Patent Application Publication
(10) Pub. No.: US 2001/0050689 A1
(43) Pub. Date: Dec. 13, 2001

(54) Method for creating human characters by partial image synthesis

(75) Inventor: Hee Wan Park, Seoul (KR)

Correspondence Address: LOWE HAUPTMAN GOPSTEIN, GILMAN & BERNER, LLP, SUITE 310, 1700 DIAGONAL ROAD, ALEXANDRIA, VA, 22314, US

(73) Assignee: MINESOFT CO., LTD.

(21) Appl. No.: 09/736,228

(22) Filed: Dec. 15, 2000

(30) Foreign Application Priority Data
Dec. 17, 1999 (KR) 99-58670

(51) Int. Cl. G09G 5/00

(52) U.S. Cl. 345/629

(57) ABSTRACT

A method is provided for creating human characters by virtue of partial image synthesis. The method comprises displaying a basic character body form, displaying a plurality of face shapes as images and synthesizing a selected one of the displayed face shape images with the basic character body form, displaying a plurality of hairstyles as images and synthesizing a selected one of the displayed hairstyle images with the basic character body form, displaying a plurality of eye shapes as images and synthesizing a selected one of the displayed eye shape images with the basic character body form, displaying a plurality of mouth shapes as images and synthesizing a selected one of the displayed mouth shape images with the basic character body form, and displaying a plurality of nose shapes as images and synthesizing a selected one of the displayed nose shape images with the basic character body form, whereby a desired human character is created. The basic character body form is synthesized with a plurality of face shape images, hairstyle images, eye shape images, mouth shape images, nose shape images, clothing style images and background images according to the user's selections, thereby enabling a variety of human characters desired by the user to be simply created with ease.

### BACKGROUND OF THE INVENTION

1. Field of the Invention

The present invention is generally directed to a human character synthesis method and more specifically to a method for creating human characters by virtue of partial image synthesis.

2. Description of the Prior Art

Widely used at the present time are sticker cameras which allow users to create so-called sticker photographs by appending a variety of backgrounds or letters to pictures taken and then printing the resulting pictures on stickers.

Such a sticker camera desirably enables a user to create a photograph in a desired form, but has a disadvantage in that it requires a photographed picture containing the actual figure of the user, resulting in the user's character being specifically fixed.

It is common that users prefer characters capable of best expressing their unique outward appearances or personalities, to their own actual figures. In this regard, human characters selectively useable by users have recently been provided on the Internet. However, it is the current reality that human characters provided on the Internet cannot satisfy customers' desires to use human characters unique to themselves, because they are not only limited in kind, but also used in common by many persons.

### SUMMARY OF THE INVENTION

Therefore, the present invention has been made in view of the above problems, and it is an object of the present invention to provide a method for creating human characters by virtue of partial image synthesis, wherein a variety of human characters desired by a user can be simply created with ease.

In accordance with the present invention, the above and other objects can be accomplished by the provision of a method for creating human characters by partial image synthesis, comprising the steps of: a) displaying a basic character body form; b) displaying a plurality of face shapes as images and synthesizing a selected one of the displayed face shape images with the basic character body form; c) displaying a plurality of hairstyles as images and synthesizing a selected one of the displayed hairstyle images with the basic character body form; d) displaying a plurality of eye shapes as images and synthesizing a selected one of the displayed eye shape images with the basic character body form; e) displaying a plurality of mouth shapes as images and synthesizing a selected one of the displayed mouth shape images with the basic character body form; and f) displaying a plurality of nose shapes as images and synthesizing a selected one of the displayed nose shape images with the basic character body form; whereby a desired human character is created.

### BRIEF DESCRIPTION OF THE DRAWINGS

The above and other objects, features and advantages of the present invention will be more clearly understood from the following description of the invention taken in conjunction with the accompanying drawings, in which:

FIG. 1 is a flowchart illustrating a method for creating human characters by partial image synthesis in accordance with the present invention;

FIG. 2 is a detailed flowchart illustrating a face shape image display/synthesis step in FIG. 1;

FIG. 3 is a view showing an exemplary picture for execution of the face shape image display/synthesis step of FIG. 2;

FIG. 4 is a detailed flowchart illustrating a hairstyle image display/synthesis step in FIG. 1;

FIG. 5 is a view showing an exemplary picture for execution of the hairstyle image display/synthesis step of FIG. 4;

FIG. 6 is a detailed flowchart illustrating an eye shape image display/synthesis step in FIG. 1;

FIG. 7 is a view showing an exemplary picture for execution of the eye shape image display/synthesis step of FIG. 6;

FIG. 8 is a detailed flowchart illustrating a mouth shape image display/synthesis step in FIG. 1;

FIG. 9 is a view showing an exemplary picture for execution of the mouth shape image display/synthesis step of FIG. 8;

FIG. 10 is a detailed flowchart illustrating a nose shape image display/synthesis step in FIG. 1;

FIG. 11 is a view showing an exemplary picture for execution of the nose shape image display/synthesis step of FIG. 10;

FIG. 12 is a detailed flowchart illustrating a clothing style image display/synthesis step in FIG. 1;

FIG. 13 is a view showing an exemplary picture for execution of the clothing style image display/synthesis step of FIG. 12;

FIG. 14 is a detailed flowchart illustrating a background image display/synthesis step in FIG. 1;

FIG. 15 is a view showing an exemplary picture for execution of the background image display/synthesis step of FIG. 14; and

FIG. 16 is a view showing an exemplary picture for execution of a human character modification step in FIG. 1.

### DESCRIPTION OF THE PREFERRED EMBODIMENTS

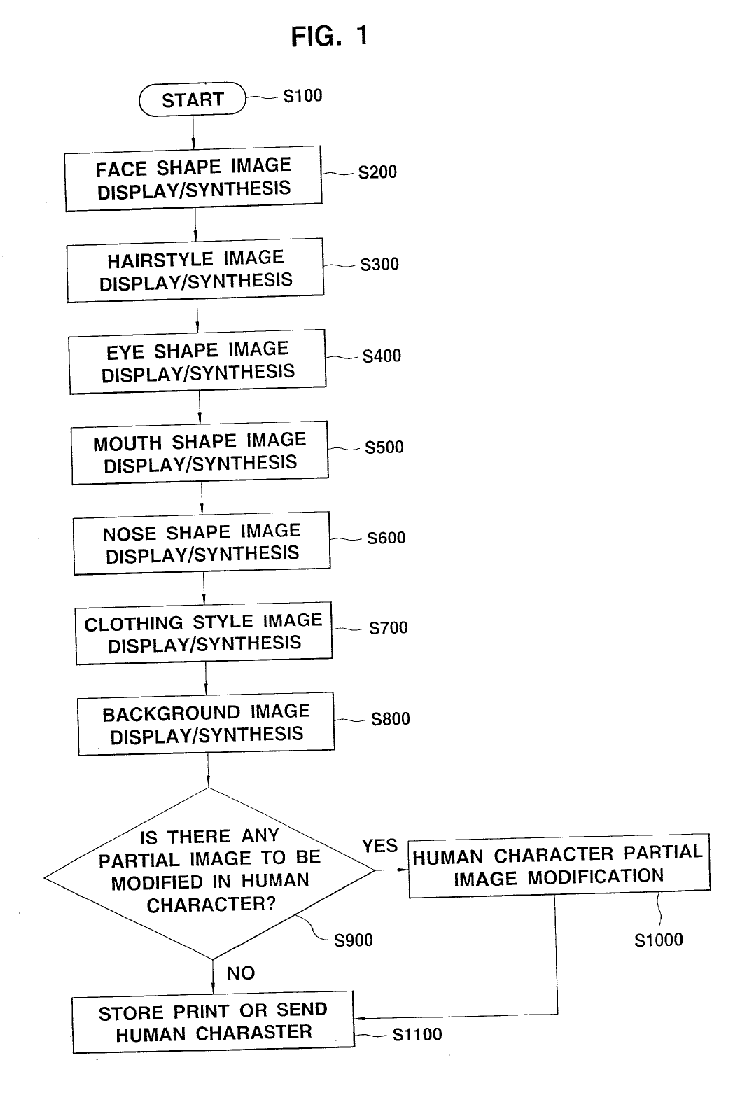

Referring to FIGS. 1 to 16, there are views illustrating a method for creating human characters by partial image synthesis in accordance with the present invention.

Although not shown in the drawings for simplicity, a system for execution of a method for creating human characters by partial image synthesis in accordance with the present invention comprises an input unit such as a mouse, a computer for executing a human character creation program of the present invention in response to signals inputted by the input unit, a monitor for displaying the results of execution by the computer on a screen, and an output unit such as a printer. This system is well known in the art and a detailed description thereof will thus be omitted.

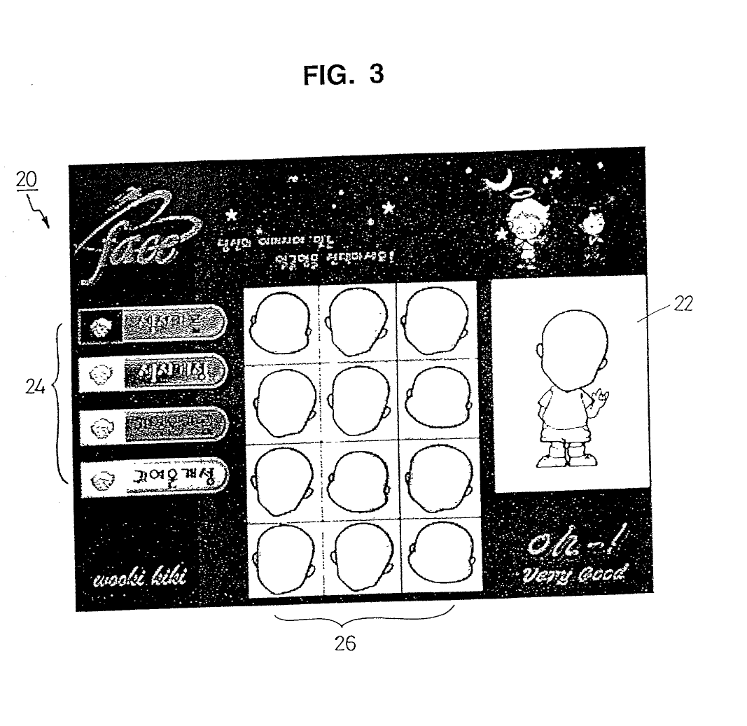

With reference to FIG. 1, at the initial time that the human character creation program is executed, a basic character body form is displayed in a face shape image synthesis window 22 of a face shape image display picture 20 shown in FIG. 3 (S100). Subsequently, a face shape image display/synthesis step S200 is performed at which a plurality of face shapes are displayed as images and a selected one of the displayed face shape images is synthesized with the basic character body form.

Provided in the face shape image display picture 20 of FIG. 3 are a plurality of face shape menu bars 24 for selecting a plurality of face shape menus, respectively, and a face shape image display window 26 for displaying a plurality of face shape images corresponding to each of the face shape menus selected respectively by the face shape menu bars 24. The face shape menu bars 24 may correspond respectively to, for example, four face shape menus, a “sexy and nicely tapered face”, “sexy and unique face”, “lovely and nicely tapered face” and “lovely and unique face”. The face shape image display window 26 may display, for example, twelve face shape images corresponding to each of the face shape menus selected respectively by the face shape menu bars 24. The face shape menu bars 24 may be appropriately changed in number if needed Similarly, the face shape images displayed in the face shape image display window 26 may be appropriately changed in number if needed.

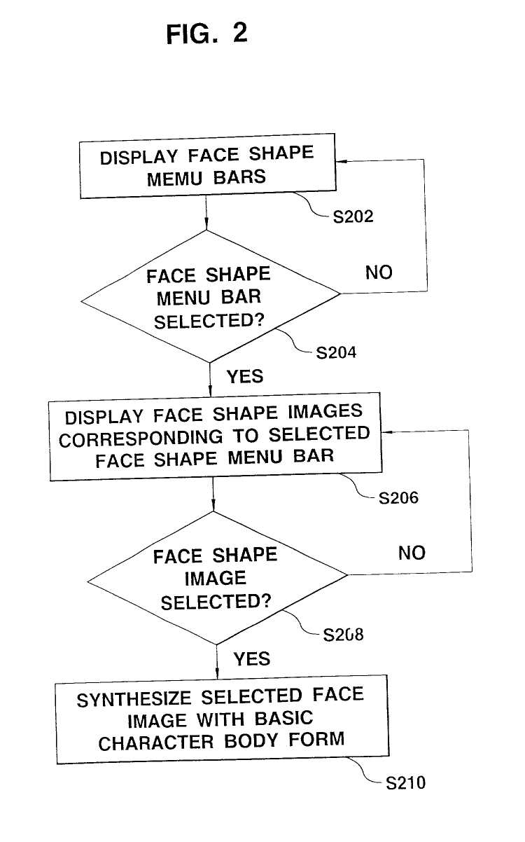

With reference to FIGS. 2 and 3, at the face shape image display/synthesis step S200, the face shape menu bars 24 are displayed on the face shape image display picture 20 (S202) and it is then determined whether any one of the displayed face shape menu bars 24 has been selected (S204). If any one of the displayed face shape menu bars 24 is determined to have been selected, then a plurality of face shape images corresponding thereto are displayed in the face shape image display window 26 (S206). However, if it is determined that none of the displayed face shape menu bars 24 have been selected, then the human character creation program returns to the above step S202.

After the face shape images corresponding to the selected face shape menu bar are displayed in the face shape image display window 26, the decision is made as to whether any one of the displayed face shape images has been selected (S208). If any one of the displayed face shape images has been selected, then it is synthesized with the basic character body form and displayed in the face shape image synthesis window 22 (S210). Alternatively, in the case where none of the displayed face shape images have been selected, the human character creation program returns to the above step S208.

Referring again to FIG. 1, after the selected face shape image is synthesized with the basic character body form and displayed in the face shape image synthesis window 22 of the face shape image display picture 20, a hairstyle image display/synthesis step S300 is performed at which a plurality of hairstyles are displayed as images and a selected one of the displayed hairstyle images is synthesized with the basic character body form.

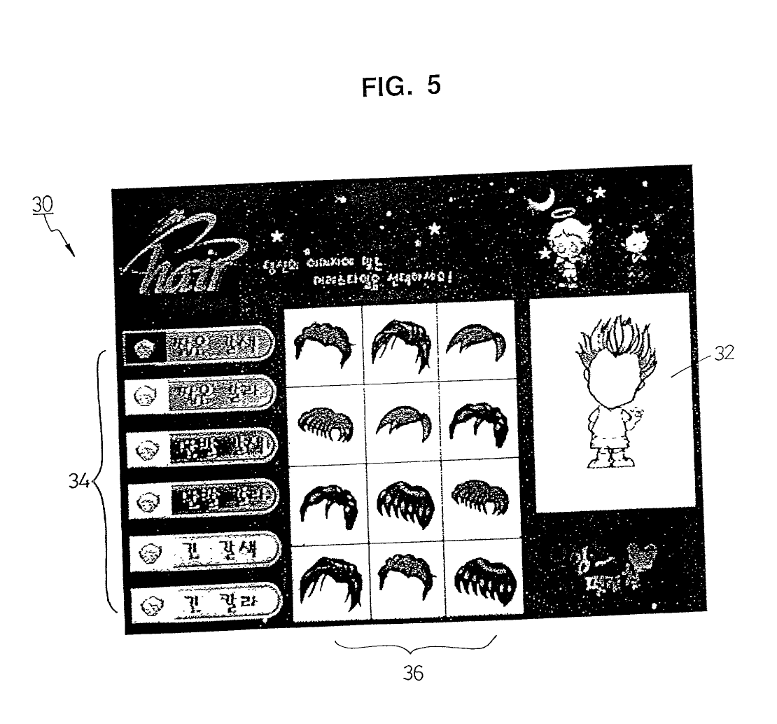

In FIG. 5, a hairstyle image display picture 30 is shown to include a hairstyle image synthesis window 32, a plurality of hairstyle menu bars 34 for selecting a plurality of hairstyle menus, respectively, and a hairstyle image display window 36 for displaying a plurality of hairstyle images corresponding to each of the hairstyle menus selected respectively by the hairstyle menu bars 34. The hairstyle menu bars 34 may correspond respectively to, for example, six hairstyle menus, a “short brown hair”, “short colored hair”, “bobbed brown hair”, “bobbed colored hair”, “long brown hair” and “long colored hair”. The hairstyle image display window 36 may display, for example, twelve hairstyle images corresponding to each of the hairstyle menus selected respectively by the hairstyle menu bars 34. The hairstyle menu bars 34 may be appropriately changed in number if needed. Similarly, the hairstyle images displayed in the hairstyle image display window 36 may be appropriately changed in number if needed.

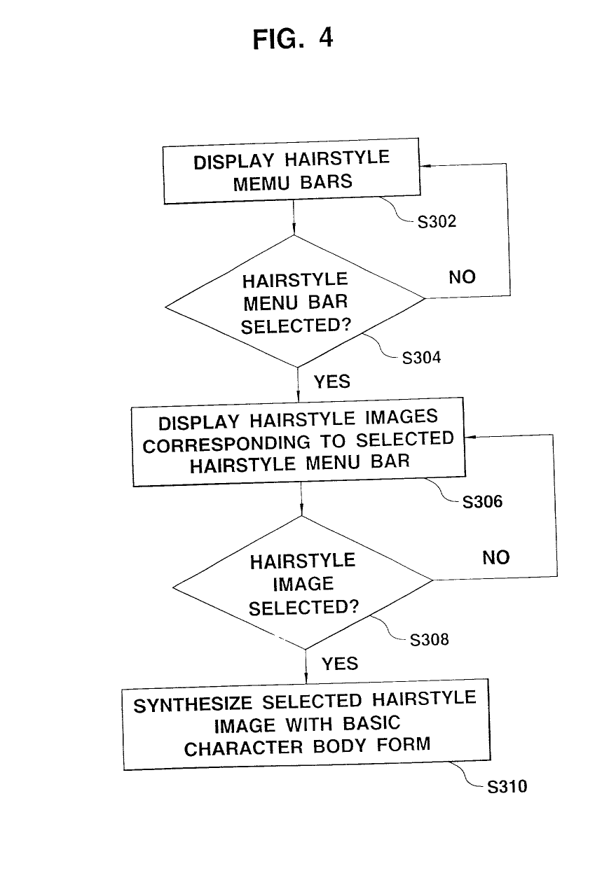

With reference to FIGS. 4 and 5, at the hairstyle image display/synthesis step S300, the hairstyle menu bars 34 are displayed on the hairstyle image display picture 30 (S302) and it is then determined whether any one of the displayed hairstyle menu bars 34 has been selected (S304). If any one of the displayed hairstyle menu bars 34 is determined to have been selected, then a plurality of hairstyle images corresponding thereto are displayed in the hairstyle image display window 36 (S306). Alternatively, if it is determined that none of the displayed hairstyle menu bars 34 have been selected, then the human character creation program returns to the above step S302.

After the hairstyle images corresponding to the selected hairstyle menu bar are displayed in the hairstyle image display window 36, the decision is made as to whether any one of the displayed hairstyle images has been selected (S308). If any one of the displayed hairstyle images has been selected, then it is synthesized with the basic character body form and displayed in the hairstyle image synthesis window 32 (S310). On the contrary, in the case where none of the displayed hairstyle images have been selected, the human character creation program returns to the above step S308.

Referring again to FIG. 1, after the selected hairstyle image is synthesized with the basic character body form and displayed in the hairstyle image synthesis window 32 of the hairstyle image display picture 30, an eye shape image display/synthesis step S400 is performed at which a plurality of eye shapes are displayed as images and a selected one of the displayed eye shape images is synthesized with the basic character body form.

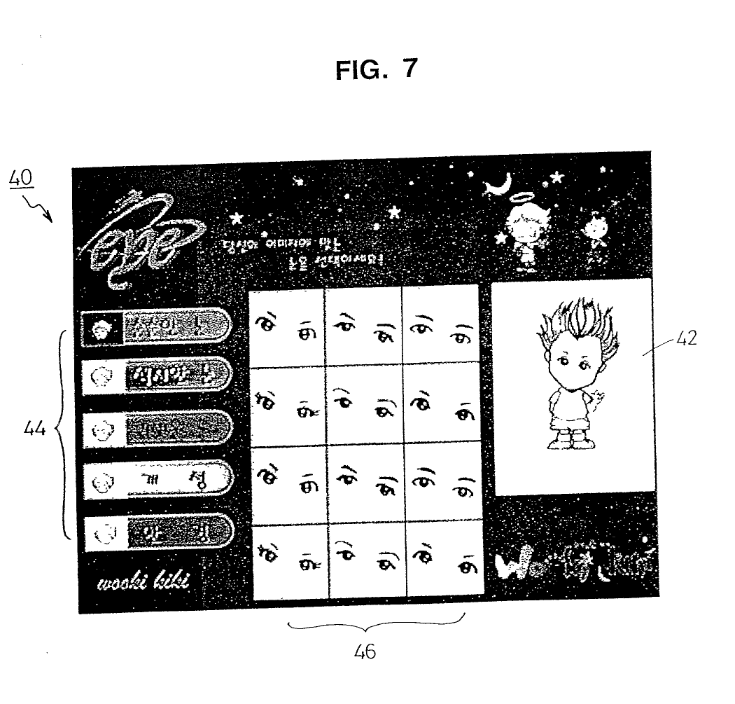

An eye shape image display picture 40 of FIG. 7 is provided with an eye shape image synthesis window 42, a plurality of eye shape menu bars 44 for selecting a plurality of eye shape menus, respectively, and an eye shape image display window 46 for displaying a plurality of eye shape images corresponding to each of the eye shape menus selected respectively by the eye shape menu bars 44. The eye shape menu bars 44 may correspond respectively to, for example, five eye shape menus, “innocent eyes”, “sexy eyes”, “lovely eyes”, “unique eyes” and “spectacled eyes”. The eye shape image display window 46 may display, for example, twelve eye shape images corresponding to each of the eye shape menus selected respectively by the eye shape menu bars 44. The eye shape menu bars 44 may be appropriately changed in number if needed. Similarly, the eye shape images displayed in the eye shape image display window 46 may be appropriately changed in number if needed.

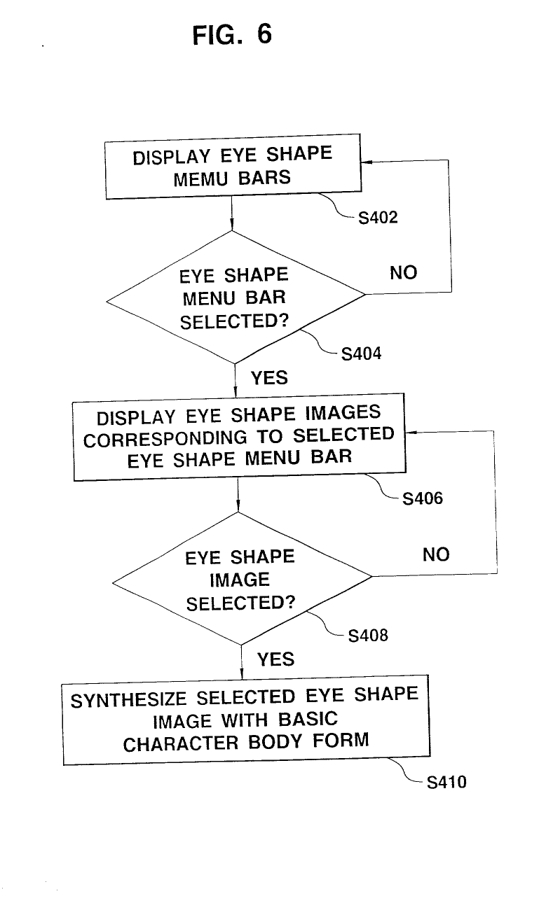

With reference to FIGS. 6 and 7, at the eye shape image display/synthesis step S400, the eye shape menu bars 44 are displayed on the eye shape image display picture 40 (S402) and it is then determined whether any one of the displayed eye shape menu bars 44 has been selected (S404). If any one of the displayed eye shape menu bars 44 is determined to have been selected, then a plurality of eye shape images corresponding thereto are displayed in the eye shape image display window 46 (S406). However, if it is determined that none of the displayed eye shape menu bars 44 have been selected, then the human character creation program returns to the above step S402.

After the eye shape images corresponding to the selected eye shape menu bar are displayed in the eye shape image display window 46, the decision is made as to whether any one of the displayed eye shape images has been selected (S408). If any one of the displayed eye shape images has been selected, then it is synthesized with the basic character body form and displayed in the eye shape image synthesis window 42 (S410). Alternatively, in the case where none of the displayed eye shape images have been selected, the human character creation program returns to the above step S408.

Referring again to FIG. 1, after the selected eye shape image is synthesized with the basic character body form and displayed in the eye shape image synthesis window 42 of the eye shape image display picture 40, a mouth shape image display/synthesis step S500 is performed at which a plurality of mouth shapes are displayed as images and a selected one of the displayed mouth shape images is synthesized with the basic character body form.

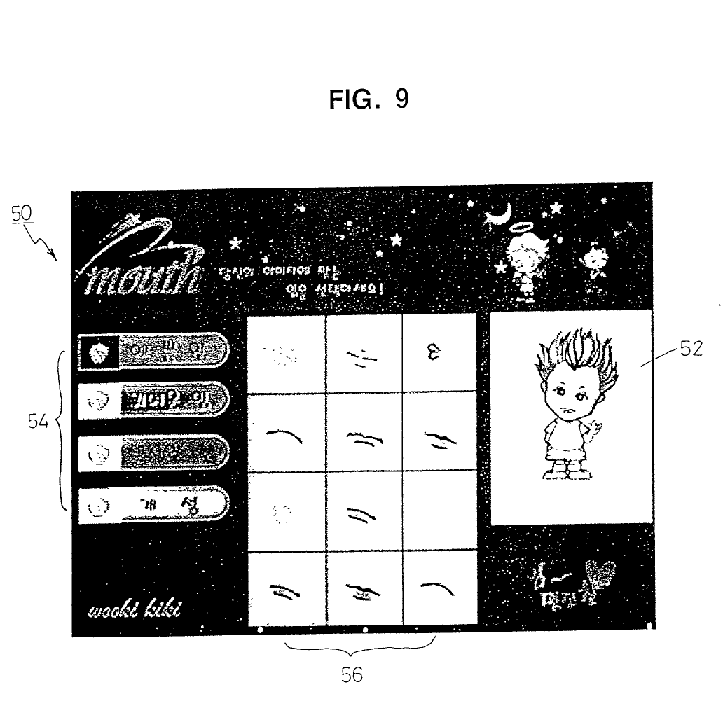

In FIG. 9, a mouth shape image display picture 50 is shown to include a mouth shape image synthesis window 52, a plurality of mouth shape menu bars 54 for selecting a plurality of mouth shape menus, respectively, and a mouth shape image display window 56 for displaying a plurality of mouth shape images corresponding to each of the mouth shape menus selected respectively by the mouth shape menu bars 54. The mouth shape menu bars 54 may correspond respectively to, for example, four mouth shape menus, a “pretty mouth”, “lovely mouth”, “sexy mouth” and “unique mouth”. The mouth shape image display window 56 may display, for example, twelve mouth shape images corresponding to each of the mouth shape menus selected respectively by the mouth shape menu bars 54. The mouth shape menu bars 54 may be appropriately changed in number if needed. Similarly, the mouth shape images displayed in the mouth shape image display window 56 may be appropriately changed in number if needed.

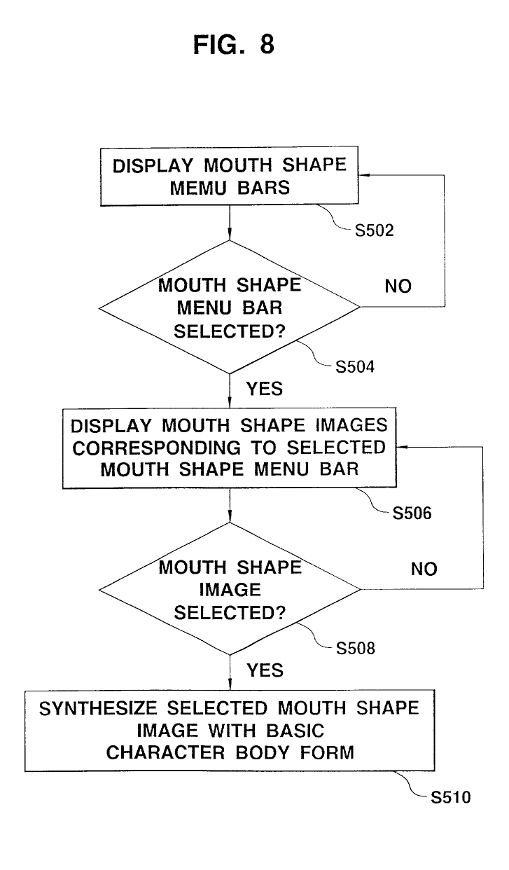

With reference to FIGS. 8 and 9, at the mouth shape image display/synthesis step S500, the mouth shape menu bars 54 are displayed on the mouth shape image display picture 50 (S502) and it is then determined whether any one of the displayed mouth shape menu bars 54 has been selected (S504). If any one of the displayed mouth shape menu bars 54 is determined to have been selected, then a plurality of mouth shape images corresponding thereto are displayed in the mouth shape image display window 56 (S506). However, in the case where it is determined that none of the displayed mouth shape menu bars 54 have been selected, the human character creation program returns to the above step S502.

After the mouth shape images corresponding to the selected mouth shape menu bar are displayed in the mouth shape image display window 56, the decision is made as to whether any one of the displayed mouth shape images has been selected (S508). If any one of the displayed mouth shape images has been selected, then it is synthesized with the basic character body form and displayed in the mouth shape image synthesis window 52 (S510). On the contrary, in the case where none of the displayed mouth shape images have been selected, the human character creation program returns to the above step S508.

Referring again to FIG. 1, after the selected mouth shape image is synthesized with the basic character body form and displayed in the mouth shape image synthesis window 52 of the mouth shape image display picture 50, a nose shape image display/synthesis step S600 is performed at which a plurality of nose shapes are displayed as images and a selected one of the displayed nose shape images is synthesized with the basic character body form.

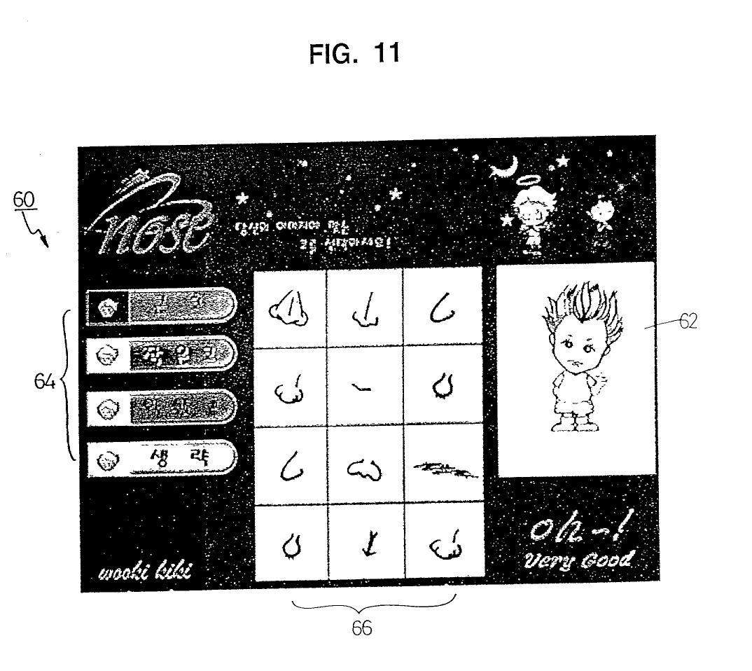

A nose shape image display picture 60 of FIG. 11 is provided with a nose shape image synthesis window 62, a plurality of nose shape menu bars 64 for selecting a plurality of nose shape menus, respectively, and a nose shape image display window 66 for displaying a plurality of nose shape images corresponding to each of the nose shape menus selected respectively by the nose shape menu bars 64. The nose shape menu bars 64 may correspond respectively to, for example, four nose shape menus, a “large nose”, “small nose”, “bulbous red nose” and “nose omission”. The nose shape image display window 66 may display, for example, twelve nose shape images corresponding to each of the nose shape menus selected respectively by the nose shape menu bars 64. The nose shape menu bars 64 may be appropriately changed in number if needed. Similarly, the nose shape images displayed in the nose shape image display window 66 may be appropriately changed in number if needed.

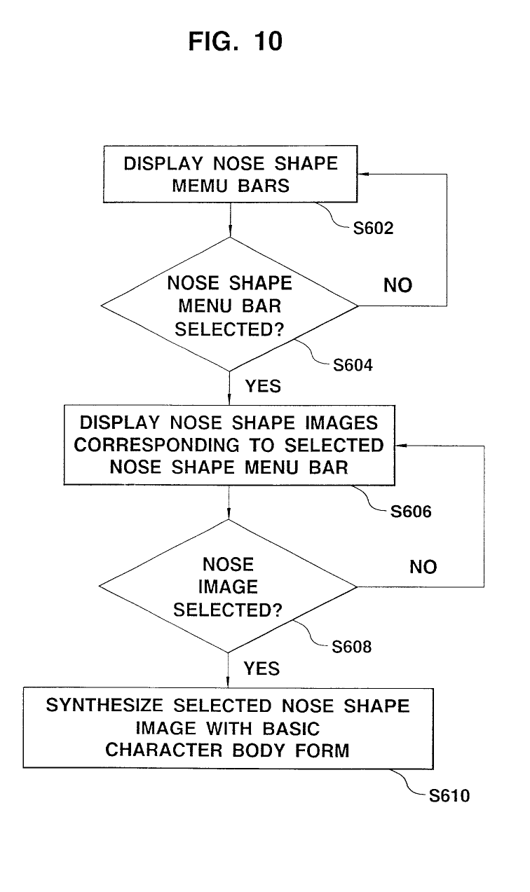

With reference to FIGS. 10 and 11, at the nose shape image display/synthesis step S600, the nose shape menu bars 64 are displayed on the nose shape image display picture 60 (S602) and it is then determined whether any one of the displayed nose shape menu bars 64 has been selected (S604). If any one of the displayed nose shape menu bars 64 is determined to have been selected, then a plurality of nose shape images corresponding thereto are displayed in the nose shape image display window 66 (S606). Alternatively, in the case where it is determined that none of the displayed nose shape menu bars 64 have been selected, the human character creation program returns to the above step S602.

After the nose shape images corresponding to the selected nose shape menu bar are displayed in the nose shape image display window 66, the decision is made as to whether any one of the displayed nose shape images has been selected (S608). If any one of the displayed nose shape images has been selected, then it is synthesized with the basic character body form and displayed in the nose shape image synthesis window 62 (S610). However, if none of the displayed nose shape images have been selected, then the human character creation program returns to the above step S608.

In this manner, a user can primarily create a desired human character by sequentially applying the face shape image display/synthesis step S200, the hairstyle image display/synthesis step S300 and the eye, mouth and nose shape image display/synthesis steps S400, S500 and S600 to the basic character body form.

Referring again to FIG. 1, after the desired human character is created, a clothing style image display/synthesis step S700 is performed at which a plurality of clothing styles for modification of the basic character body form are displayed as images and a selected one of the displayed clothing style images is synthesized with the basic character body form.

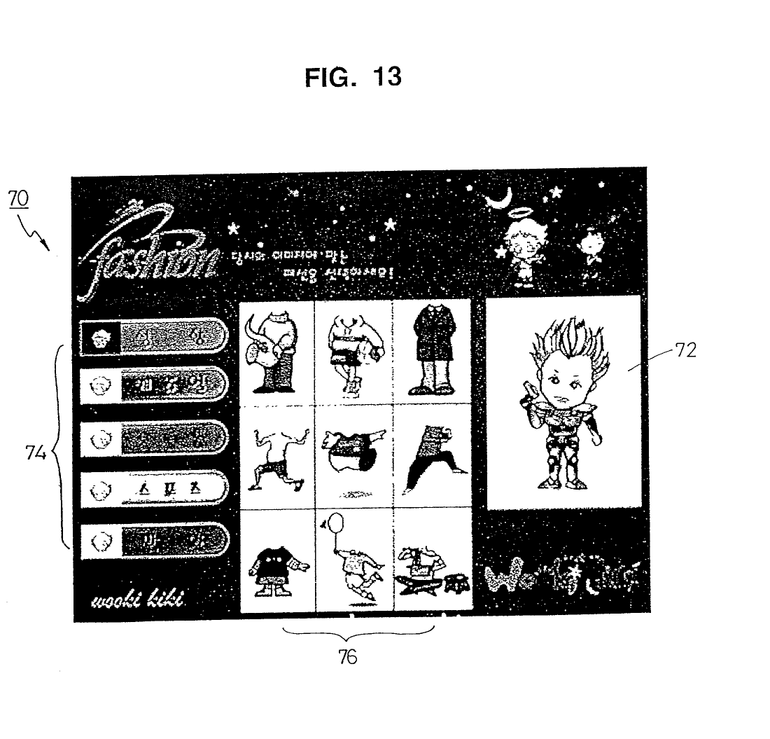

In FIG. 13, a clothing style image display picture 70 is shown to include a clothing style image synthesis window 72, a plurality of clothing style menu bars 74 for selecting a plurality of clothing style menus, respectively, and a clothing style image display window 76 for displaying a plurality of clothing style images corresponding to each of the clothing style menus selected respectively by the clothing style menu bars 74. The clothing style menu bars 74 may correspond respectively to, for example, five clothing style menus, “formal dress”, “casual wear”, “uniform”, “sports wear” and “animation dress”. The clothing style image display window 76 may display, for example, twelve clothing style images corresponding to each of the clothing style menus selected respectively by the clothing style menu bars 74. The clothing style menu bars 74 may be appropriately changed in number if needed. Similarly, the clothing style images displayed in the clothing style image display window 76 may be appropriately changed in number if needed.

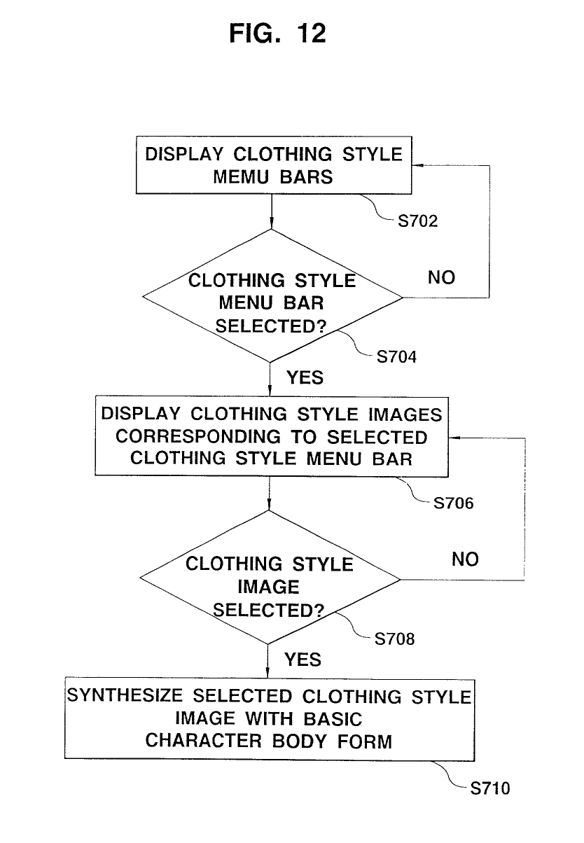

With reference to FIGS. 12 and 13, at the clothing style image display/synthesis step S700, the clothing style menu bars 74 are displayed on the clothing style image display picture 70 (S702) and it is then determined whether any one of the displayed clothing style menu bars 74 has been selected (S704). If any one of the displayed clothing style menu bars 74 is determined to have been selected, then a plurality of clothing style images corresponding thereto are displayed in the clothing style image display window 76 (S706). Alternatively, if it is determined that none of the displayed clothing style menu bars 74 have been selected, then the human character creation program returns to the above step S702.

After the clothing style images corresponding to the selected clothing style menu bar are displayed in the clothing style image display window 76, the decision is made as to whether any one of the displayed clothing style images has been selected (S708). If any one of the displayed clothing style images has been selected, then it is synthesized with the basic character body form and displayed in the clothing style image synthesis window 72 (S710). On the contrary, in the case where none of the displayed clothing style images have been selected, the human character creation program returns to the above step S708.

Referring again to FIG. 1, after the basic character body form is modified by the selected clothing style image and the resulting human character is displayed in the clothing style image synthesis window 72 of the clothing style image display picture 70, a background image display/synthesis step S800 is performed at which a plurality of backgrounds are displayed as images and a selected one of the displayed background images is synthesized with the human character.

A background image display picture 80 of FIG. 7 is provided with a background image synthesis window 82, a plurality of background menu bars 84 for selecting a plurality of background menus, respectively, and a background image display window 86 for displaying a plurality of background images corresponding to each of the background menus selected respectively by the background menu bars 84. The background menu bars 84 may correspond respectively to, for example, two background menus, a “background picture” and “picture frame”. The background image display window 86 may display, for example, twelve background images corresponding to each of the background menus selected respectively by the background menu bars 84. The background menu bars 84 may be appropriately changed in number if needed. Similarly, the background images displayed in the background image display window 86 may be appropriately changed in number if needed.

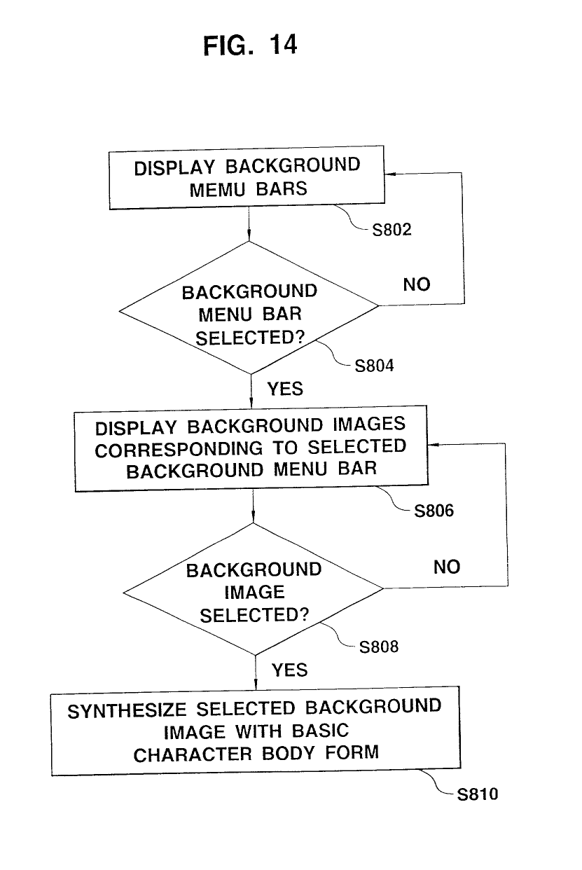

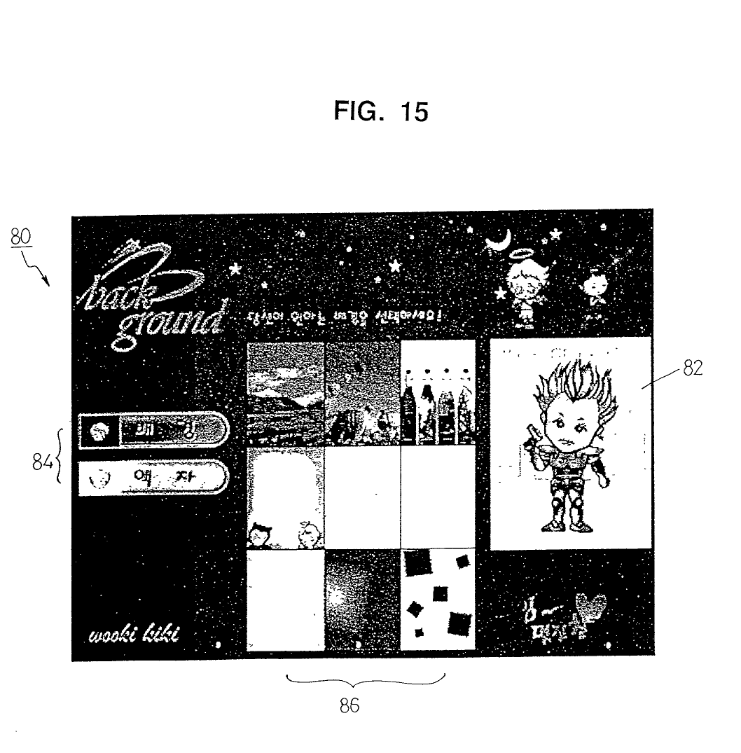

With reference to FIGS. 14 and 15, at the background image display/synthesis step S800, the background menu bars 84 are displayed on the background image display picture 80 (S802) and it is then determined whether any one of the displayed background menu bars 84 has been selected (S804). If any one of the displayed background menu bars 84 is determined to have been selected, then a plurality of background images corresponding thereto are displayed in the background image display window 86 (S806). However, if it is determined that none of the displayed background menu bars 84 have been selected, then the human character creation program returns to the above step S802.

After the background images corresponding to the selected background menu bar are displayed in the background image display window 86, the decision is made as to whether any one of the displayed background images has been selected (S808). If any one of the displayed background images has been selected, then it is synthesized with the human character and displayed in the background image synthesis window 82 (S810). Alternatively, in the case where none of the displayed background images have been selected, the human character creation program returns to the above step S808.

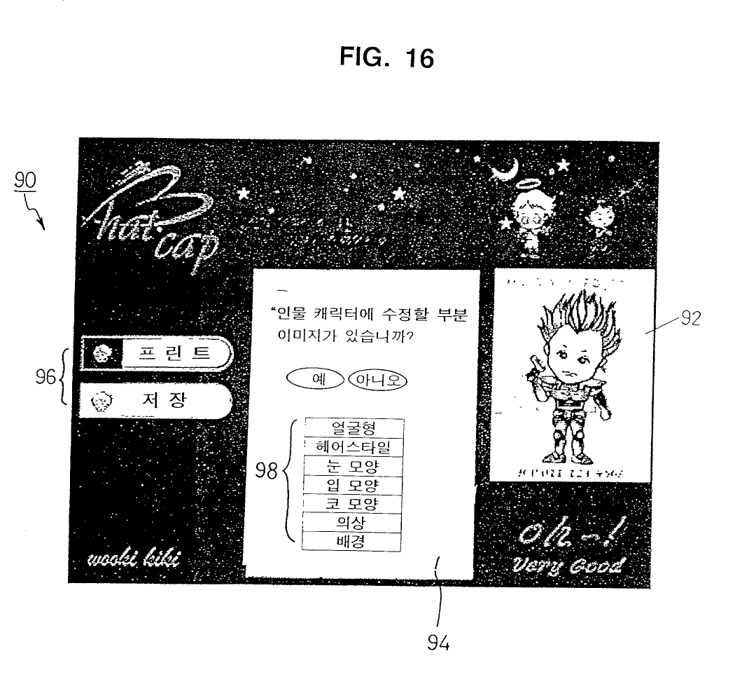

With reference to FIG. 16, a final picture 90 is provided with a human character window 92 for displaying a completed human character, a message window 94 for displaying messages, and a plurality of menu bars 96.

In FIGS. 1 and 16, after the completed human character is displayed in the human character window 92 of the final picture 90, a query message, for example, “Is there any partial image to be modified in the human character ?” and an answering message, for example, “Yes” and “No” are displayed in the message window 94.

If the messages are displayed in the message window 94 of the final picture 90 as stated above, then the decision is made about whether there is any partial image to be modified in the completed human character in the human character window 92 (S900). If there is any partial image to be modified in the completed human character, a plurality of modification menu bars 98 are displayed in the message window 94 of the final picture 90. The modification menu bars 98 may correspond respectively to, for example, seven modification menus, a “face shape”, “hairstyle”, “eye shape”, “mouth shape”, “nose shape”, “clothing style” and “background” such that, as any one thereof is selected, the human character creation program returns to a corresponding one of the above-stated human character partial image synthesis steps. If, with any one of the modification menu bars 98 selected, the human character creation program returns to a corresponding one of the above-stated human character partial image synthesis steps to execute it again, then a human character partial image modification step S1000 is performed at which the image of the human character is partially modified. At this partial image modification step S1000, the user may change the color of the human character to a desired one or draw, for example, paint a desired shape in the human character.

On the other hand, in the case where there is no partial image to be modified in the completed human character displayed in the human character window 92 of the final picture 90, the human character is printed on, for example, a sticker (S1100). The printing of the human character is executed by selecting a “print” menu bar from among the menu bars 96 of the final picture 90. Also, the human character can be stored in a computer or disc by selecting a “storage” menu bar from among the menu bars 96. The human character stored in the computer or disc may then be used, for example, as a background picture of Windows or a picture file of an Internet homepage or word processor. It may also be possible for a user to send the synthesized human character in the form of an e-mail to another user through the use of telecommunication devices

If needed, the human character creation method of the present invention may further comprise an accessory image display/synthesis step which is performed in the same manner as either the clothing style image display/synthesis step S700 or , background image display/synthesis step S800 noted above. At the accessory image display/synthesis step, a plurality of accessories such as a hat, etc. are displayed as images and a selected one of the displayed accessory images is synthesized with the human character. Further, the human character creation method of the present invention may comprise a message display/synthesis step of displaying a plurality of messages such as letters, symbols, etc. and appending a selected one of the displayed messages to a background image.

As apparent from the above description, the present invention provides a method for creating human characters by partial image synthesis, wherein a basic character body form is synthesized with a plurality of face shape images, hairstyle images, eye shape images, mouth shape images, nose shape images, clothing style images and background images according to user's selections, thereby enabling a variety of human characters desired by the user to simply and conveniently be created.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for creating human characters by partial image synthesis, comprising the steps of:
a) displaying a basic character body form;
b) displaying a plurality of face shapes as images and synthesizing a selected one of the displayed face shape images with said basic character body form;
c) displaying a plurality of hairstyles as images and synthesizing a selected one of the displayed hairstyle images with said basic character body form;
d) displaying a plurality of eye shapes as images and synthesizing a selected one of the displayed eye shape images with said basic character body form;
e) displaying a plurality of mouth shapes as images and synthesizing a selected one of the displayed mouth shape images with said basic character body form; and
f) displaying a plurality of nose shapes as images and synthesizing a selected one of the displayed nose shape images with said basic character body form;
whereby a desired human character is created.

2. The method as set forth in claim 1, further comprising the step of: g) displaying a plurality of clothing styles for modification of said basic character body form as images and synthesizing a selected one of the displayed clothing style images with said basic character body form.

3. The method as set forth in claim 1, further comprising the step of: g) displaying a plurality of backgrounds as images and synthesizing a selected one of the displayed background images with said desired human character.

4. The method as set forth in claim 2, further comprising the step of: h) printing said desired human character on a sticker.

5. The method as set forth in claim 3, further comprising the step of: h) printing said desired human character on a sticker.

6. The method as set forth in claim 1, further comprising the step of: h) sending said desired human character as an e-mail through the use of telecommunication devices.
